(19) United States
(12) Patent Application Publication
(10) Pub. No.: US 2005/0166771 A1
(43) Pub. Date: Aug. 4, 2005

(54) Device for unsticking security elements

(76) Inventors: Matthias Gygi, Montreux (CH); Raffaele Fina, Lausanne (CH)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/496,061

(22) PCT Filed: Nov. 19, 2002
(86) PCT No.: PCT/IB02/04821

(30) Foreign Application Priority Data
Nov. 23, 2001 (EP) 01811129.4

(51) Int. Cl. B41F 19/06

(52) U.S. Cl. 101/35

(57) ABSTRACT

The invention relates to a device comprising means for unsticking a ribbon (20) comprising security elements from a sheet (16). Said unsticking means are provided with at least one unsticking roll (28) along which the ribbon (20) moves approximately perpendicularly to the surface of the sheet (16).

The present invention relates to a device for separating a band carrying security elements and a sheet to which said security elements have been applied, said device comprising means for detaching the band from the sheet.

The present invention also relates to a machine comprising at least one such separation device.

In the prior art, it is known to apply security elements to paper currency and, in particular, to banknotes or credit cards. Such control elements are well known and are used mainly for preventing the counterfeiting of paper currency, in particular the copying of banknotes. In order to make this counterfeiting, either by photocopy or by use of a scanner coupled to a color printer, difficult or even impossible, control elements, commonly called security elements, have begun to be incorporated into the printed paper currency in addition to the special means already used, such as, for example, watermarks in the paper or special printing techniques.

To be precise, the technical advances relating to photocopiers and scanners are such that high-performance equipment is now readily accessible to anyone. The security elements have therefore themselves had to be increased in diversity and improved accordingly.

Various techniques have been developed in order to produce security elements for paper currency. In addition to the printing of images by means of latent colors, it is known to apply particular images to the prints. These images comprise an optically variable image (OVD) in the form of a hologram or kinegram, the appearance of which changes as a function of the angle at which the image is viewed. The application of these images, which are carried on a band, may take place under hot or cold conditions. As an example, the patent application EP 0 625 466, the contents of which are incorporated in the present application by reference, describes an installation allowing such cold application to banknotes, using a two-component adhesive, the first component being applied at the location provided on each banknote and the second being on the image itself.

The publication EP 0 965 446, the contents of which are incorporated in the present application by reference, describes another machine for the hot application of security images to banknotes. In this machine, the band is preheated upstream of the applicator cylinder, and then the images are transferred onto intended locations on the banknote prints by means of pads placed on the applicator cylinder, by means of pressure against a pressure cylinder.

Finally, the publication EP 0 768 189, the contents of which are incorporated in the present application by reference, shows that a document, such as paper currency, comprising a security element in the form of a film which is attached permanently to said document and which cannot be modified or removed without being damaged.

In addition to the register of the images with respect to the prints, a crucial step in the method of applying such images to prints is that of the detachment of the image from the band carrying it, when said band is moved away from the sheet comprising the prints. Since the applied images are very fine, so that it is not possible to modify or remove them without damaging them irreparably, it is necessary, on the one hand, that the adhesive bond is perfect and, on the other hand, that, during the retraction of the image support, usually a band, said images are not damaged.

The solution which is known at the present time is to use a system which presses the band against the sheet to which the image is applied after the applicator cylinders, and the band/sheet separation occurs just after this compression. This device comprises, in particular, a pressure element with an inclined plane, the thinner end of which presses the band against the sheet, and subsequently, the band is detached by assuming a direction approximately perpendicular to the surface of the sheet.

It nevertheless became apparent that such a system which grips the band against the sheet had some disadvantages. The first risk which arises is a tear of the band. Such a tear is highly troublesome, since, because the band is often used continuously to pass through the machine several times, time will be lost in reinitializing the machine and lengths of band, together with images, will also be lost, this being highly costly.

Another problem is that dust is generated by friction, which soils the machine and requires a more frequent cleaning of the latter.

Finally, and in spite of the pressure, detachment was, in fact, not perfect, and residues of adhesive (called “flakes”) soil the sheets, and even images are applied outside the locations provided on the sheets. To be precise, as mentioned above and described in the application EP 0 965 446, the same band may pass through the same machine several times: the distance between two successive locations for an image on two successive prints of the same sheet is often greater than the distance between two successive images on the band. Consequently, to optimize use of the band, the latter passes through the machine several times, so that two successive images on the band are, in fact, intended for prints located on different sheets. It is therefore necessary to detach a given image, without damaging the following image on the band, otherwise a print on another sheet, for example the following sheet, will receive the damaged image and will be rejected at quality control.

The object of the invention is therefore to improve the known systems by overcoming the disadvantages of these.

More particularly, the object of the invention is to provide a simple detachment system which has reduced maintenance and which can be set quickly.

The invention is characterized in that the detachment means comprise at least one detachment roller, along which the band passes approximately perpendicularly to the surface of the sheet.

One of the advantages of this invention is its great actual simplicity. Moreover, since there is no longer any compression of the band and of the sheet, the risk of a tear of the band is markedly reduced, as is the generation of dust.

The invention also runs counter to a technical prejudice: to be precise, it was always thought that a compression of the band against the sheet was indispensable in order to perfect the transfer of the image onto the sheet. Thus, empirical adjustments were always carried out in order to ensure a particular compression, without excessive bearing contact, so as to prevent the tearing of the band and an excessive generation of dust. Moreover, it was necessary to adjust the system regularly in order to compensate the wear of the inclined plane.

The invention will be understood more clearly from the description of its embodiments and from the figures relating to it.

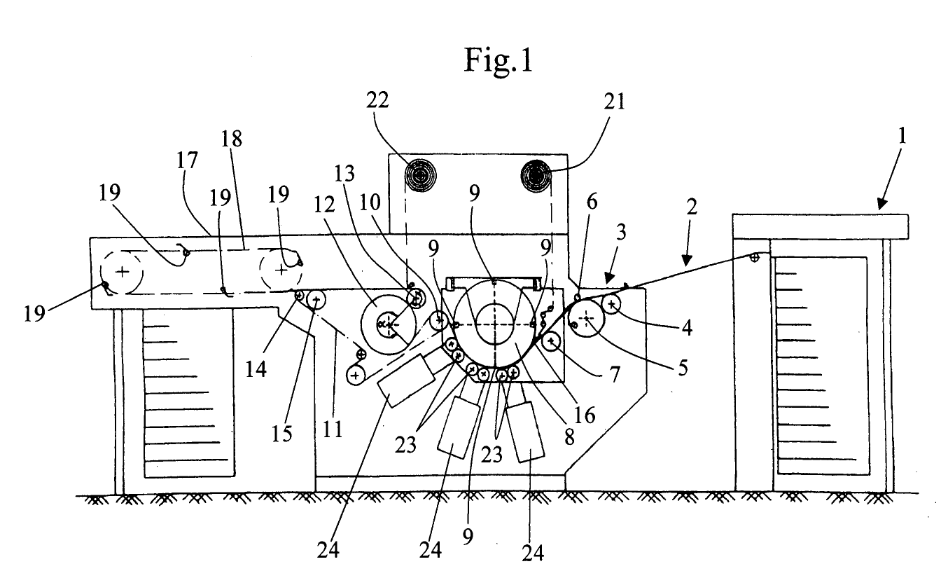

FIG. 1 shows diagrammatically a printing machine carrying out the application of security elements to sheets.

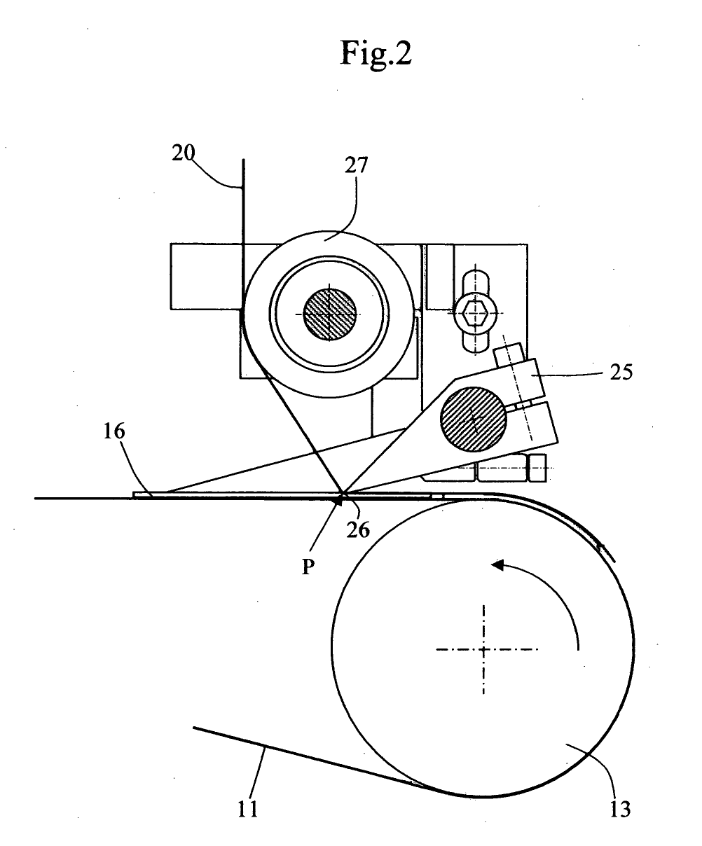

FIG. 2 shows a detachment device known in the prior art.

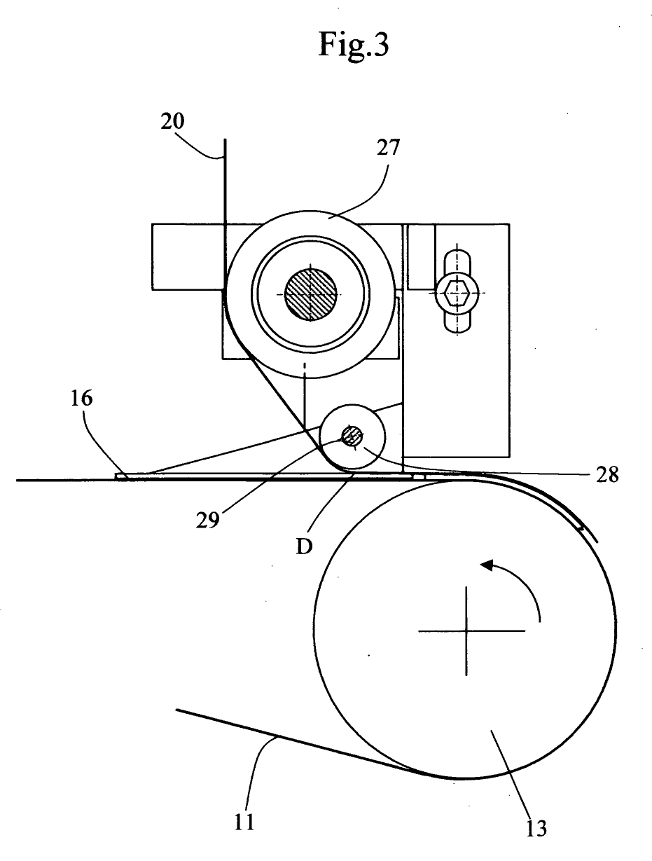

FIG. 3 shows a detachment device according to the invention.

A print machine making it possible to apply security elements according to the invention is illustrated diagrammatically in FIG. 1. A feeder 1 mounted upstream of a sheet processing machine is provided with a sheet transport system 2 which leads to a sheet supply installation 3. The sheet supply installation 3 comprises, for example, a first suction drum 4 and a transfer drum 5. Downstream of this drum 5 is provided a plurality of rollers 6 for guiding the sheets on the transfer drum 5. These sheet guide rollers 6 are arranged with their axes parallel to the transfer drum 5. A second transfer drum 7 brings the sheets to a processing cylinder 8 of the processing machine. The processing cylinder 8 is provided with four retention systems 9, for example suction belts, extending axially and distributed uniformly over the circumference. These suction belts are subjected in a controlled manner to air under a vacuum or air under pressure by means of a rotary introduction device. Downstream of the processing cylinder 8 is arranged a guide roller 10 of a conveyor belt system 11. Around this guide roller 10 is guided a plurality of conveyor belts 11 juxtaposed in the axial direction. However, it is also possible to arrange only a single wide conveyor belt 11.

These conveyor belts 11 lead from this guide roller 10 to a cooling roller 12 and surround the latter according to a predetermined angle, and an additional guide roller 13 is arranged after the cooling roller 12. The conveyor belts 11 surround the guide roller 13 according to a predetermined angle and arrive at a third guide roller 14 in an approximately horizontal direction. Just before this third guide roller 14 is arranged, below the conveyor belts 11 and between the conveyor belts 11, a suction drum 15, the peripheral surface of which is tangential to the transport plane of the sheets 16 in this zone. This suction drum 15 may also be arranged directly after the conveyor belts 11. An exit 17, known per se, is connected to the conveyor belts 11. This exit 17 is provided with a rotary chain conveyor, to the two chains 18 of which is fastened a plurality of gripper systems 19. In the present example, the processing machine is produced in the form of a band stamping machine and the processing cylinder is a stamping cylinder 8 here. In the present example, the stamping cylinder 8 is provided on its peripheral surface with hot stamps which are heated electrically. Energy is supplied to the hot stamps on the stamping cylinder 8, for example, by means of transformers. In the present example, the stamping cylinder 8 has arranged above it a device, not illustrated in any more detail, which is intended for the supply and removal of an endless supporting band 20, for example a hot-stamping band. The supporting band 20 is brought to the stamping cylinder 8 by means of a winding station 21 and is guided, together with the sheets 23, all round the stamping cylinder 8. The supporting band 20 is guided as far as the first guide roller 10 of the conveyor belts 11 and from there, jointly with the conveyor belts 11, around the cooling roller 12 as far as the second guide roller 13 of the conveyor belts 11. A device for the detachment of the band 20 is arranged after this second guide roller 13. From this device for the detachment of the band 20, the supporting band 20 is brought to a winding station 22. Below the stamping cylinder 8 is arranged a plurality of contact rollers 23 cooperating with the stamping cylinder 8. In the present example, two rows of contact rollers 23 extending axially are pressed elastically against the stamping cylinder 8 by means of pneumatic cylinders 24.

This known machine is described in detail in the patent EP 0 888 239, and the contents of this patent are incorporated in the present application by reference.

FIG. 2 shows in detail a device for the detachment of the band which is known in the prior art. In this system, the sheet 16 and the band 20 are transported together on the belts 11 around the roller 13 and arrive in the detachment device itself. In this device, a pressure element 25 is used, comprising an inclined plane, the tip 26 of which exerts a pressure on the band 20 and the sheet 16 at the point P. As soon as this point P is passed, the band 20 is separated from the sheet 16 by detachment, passes tangentially along a roller 27 and continues as far as the winding station 22 (FIG. 1). The sheet is itself transported by the belts 11 into the exit of the machine.

FIG. 3 shows in detail an embodiment of the detachment device according to the invention. According to this embodiment, identical elements are identified by the same reference numerals. As in FIG. 2, the sheet 16 and the band 20 are displaced by means of the conveyor belts 11 and arrive in the detachment device. In this detachment device, the pressure element 25 is replaced by a detachment roller 28 mounted on an axis 29 parallel to the axis of the roller 13. In this case, the detachment roller 28 is not in contact with the sheet 16 and does not exert pressure between said sheet and the band 20, in contrast to the pressure element 25 of FIG. 2.

The distance between the detachment roller 28 and the sheet 16 is preferably between 5 and 10 mm.

Preferably, the detachment roller 28 is mounted freely in terms of rotation on an axis 29.

As indicated in the figure, the detachment of the band 20 with respect to the sheet 16 occurs approximately at the point D in FIG. 3. It becomes apparent that, in a surprising and unexpected way, the absence of pressure before the detachment of the band 16 is actually beneficial to said detachment method, and that this particular design effects a much better detachment in which residues and various deposits are greatly reduced. Of course, since there is no longer any pressure on the band, the generation of dust and of residues is greatly reduced or even eliminated.

The invention is not limited to the embodiment described, and protection extends to the means equivalent to those described.

1. A device for separating a band carrying security elements and a sheet to which said security elements have been applied, said device comprising means for detaching the band from the sheet, characterized in that said detachment means comprise at least one detachment roller, along which the band passes approximately perpendicularly to the surface of the sheet.

2. The device as claimed in claim 1, characterized in that said detachment roller is located at a predetermined distance from the surface of the sheet.

3. The device as claimed in claim 2, characterized in that said detachment roller is located at a distance varying between 5 and 10 mm from the surface of the sheet.

4. The device as claimed in claim 3, characterized in that said detachment roller is mounted freely in terms of rotation on its axis.

5. A machine for the transfer of security elements onto documents, in particular onto paper currency sheets, characterized in that it comprises a device for separating a band carrying security elements and a sheet to which said security elements have been applied, said device comprising means for detaching the band from the sheet, characterized in that said detachment means comprise at least one detachment roller, along which the band passes approximately perpendicularly to the surface of the sheet.

6. The machine as claimed in claim 5, characterized in that said detachment roller is located at a predetermined distance from the surface of the sheet.

7. The machine as claimed in claim 5, characterized in that said detachment roller is located at a distance varying between 5 and 10 mm from the surface of the sheet.

8. The machine as claimed in claim 5, characterized in that said detachment roller is mounted freely in terms of rotation on its axis.
